(19) United States
(12) Patent Application Publication
(10) Pub. No.: US 2007/0033082 A1
(43) Pub. Date: Feb. 8, 2007

(54) Methods and systems for promoting positive youth development

(75) Inventors: David A. Hilliard, Pacific, MO (US); Claire Wyneken, St. Louis, MO (US); Cheryl Riley, House Springs, MO (US)

Correspondence Address: JOHN S. BEULICK;C/O ARMSTRONG TEASDALE, LLP, ONE METROPOLITAN SQUARE, SUITE 2600, ST LOUIS, MO, 63102-2740, US

(73) Assignee: Wyman Center, Inc.

(21) Appl. No.: 11/488,391

(22) Filed: Jul. 18, 2006

Related U.S. Application Data
(60) Provisional application No. 60/704,598, filed on Aug. 2, 2005.

(51) Int. Cl. G06F 9/44

(52) U.S. Cl. 705/7; 705/10

(57) ABSTRACT

A method for promoting positive youth development using a computer system coupled to a database is provided. The method includes selecting youths for inclusion in a youth development program by applying a pre-determined selection criteria to data stored within the database, providing a development plan to each selected youth wherein the development plan includes a set of goals to be achieved over a specific period of time and a set of tasks to be performed to facilitate achieving the set of goals, monitoring the selected youth within a residential summer camp portion of the youth development program, tracking and monitoring family and community service involvement by the selected youth outside of the summer camp portion of the development program, tracking and monitoring continuing education expectations of the selected youth, and verifying an ongoing connection between the selected youth and youth development program staff for a predetermined period of time.

### CROSS REFERENCE TO RELATED APPLICATIONS

This application claims priority to U.S. Provisional Patent Application Ser. No. 60/704,598, filed Aug. 2, 2005, the contents of which are hereby incorporated by reference.

### BACKGROUND OF THE INVENTION

This invention relates generally to positive youth development and, more particularly, to network-based methods and systems for providing assistance in promoting positive youth development.

A significant percentage of today's youth are considered to be “at-risk” of failing to become positive contributors to society. The sources of these risks are varied. However, a commonality in at least some of these at-risk youth situations is that such at-risk youths are not exposed to a sufficient number of positive role models, and their lives do not regularly expose them to resources that help them to develop their positive assets and enable them to achieve their full potential. In at least some of these known at-risk situations, the at-risk youths do not develop into contributors to the improvement of their community.

There are many service organizations (e.g., civic, faith-based, charitable) that attempt to provide the positive influences to at-risk youths within the community in which these organizations are based. However, at least some of these organizations implement their own plans and methods when establishing programs for these youths. While at least some of these programs are successful, however, few of these program have been implemented as a result of research combined with a carefully executed experience. In addition, many of these service organization programs are purposely scheduled around the school year, for example, as a summer program. Therefore, many of these programs are one time experiences for the youths that are served. These types of programs fail to provide a comprehensive, multi-year, and year round program for such youths.

### BRIEF DESCRIPTION OF THE INVENTION

In one aspect, a method for promoting positive youth development using a computer system coupled to a database is provided. The method includes selecting youths for inclusion in a youth development program by applying a pre-determined selection criteria to data stored within the database, providing a development plan to each selected youth wherein the development plan includes a set of goals to be achieved over a specific period of time and a set of tasks to be performed to facilitate achieving the set of goals, monitoring the selected youth within a residential summer camp portion of the youth development program, tracking and monitoring family and community service involvement by the selected youth outside of the summer camp portion of the development program, tracking and monitoring continuing education expectations of the selected youth, and verifying an ongoing connection between the selected youth and youth development program staff for a predetermined period of time.

In another aspect, a network-based system for promoting positive youth development is provided. The system includes a server system, a database for storing information and at least one client system. The server system is connected to the database and the at least one client system. The server system is configured to apply a selection criteria to data stored within the database wherein the data relates to a group of youth candidates, select youths from the group of youth candidates to participate in a youth development program wherein the selected youths satisfy the selection criteria applied to the data stored within the database, generate a development plan for the selected youth wherein the development plan includes a set of goals to be achieved over a specific period of time and a set of tasks to be performed to facilitate achieving the set of goals, receive input data relating to the selected youth wherein the input data includes data relating to the youth's participation in school and within a residential summer camp, track progress of the selected youth in satisfying the provided development plan, compare the progress of each of the selected youth to the development plan assigned to the corresponding youth, and receive feedback data from at least one of the selected youths, the family of the selected youths, and the youth development program staff.

### BRIEF DESCRIPTION OF THE DRAWINGS

FIG. 1 is a simplified block diagram of a system utilized in the promotion of positive youth development.

FIG. 2 is an expanded block diagram of an exemplary embodiment of a server architecture utilized in the promotion of positive youth development.

FIG. 3 is a flowchart illustrating an exemplary process for promoting positive youth development.

### DETAILED DESCRIPTION OF THE INVENTION

As explained above, methods and systems for promoting positive youth development are described herein. Such methods and systems include facilitating positive youth development for individuals enrolled in a youth development program. While exemplary embodiments of the methods and systems are described herein in the context of a network-based electronic architecture, such methods and systems can be implemented and practiced in many different environments and are not limited to such an electronic architecture. With respect to the network-based electronic architecture, the systems and processes facilitate, for example, electronic submission of information using a client system, automated extraction of information, and web-based reporting for internal and external system users. A technical effect of the systems and processes described herein include at least one of permitting an entity to manage, budget, track, measure and report the progression and interaction with youth enrolled, or considered for enrollment, in a positive youth development program.

A method for promoting positive youth development is set forth in Appendix A. The systems and processes described herein generally include the following steps:

1. select youth for inclusion in the youth development program based on selection criteria applied to data stored within a database by a computer system,

2. provide a selected youth included within the youth development program with a development plan that includes a set of goals to be achieved over a specific period of time and a set of tasks to be performed by the selected youth to facilitate achieving the set of goals wherein the development plan is designed for providing positive youth development,

3. monitor the selected youth within a residential summer camp portion of the development program,

4. track and monitor family and community service involvement outside of the summer camp portion of the program,

5. track and monitor continuing education expectations of the selected youth enrolled in the youth development program,

6. verify an ongoing connection between the selected youth and youth development program staff for a predetermined period of time,

7. evaluate progress of the selected youth in satisfying the development plan via the computer system,

8. evaluate the youth development program based on feedback from at least one of the selected youth, the family of the selected youth and the youth development program staff, and

9. based on the progress of the selected youth, recommend adjustments to the youth development program that will improve the results of the program.

At least some of the parties that may be involved in these systems and processes include the youths themselves, family members, youth development program staff, community partners, and school teachers and counselors. For example, a member of the youth development program staff may send monthly E-mails to youths enrolled in the youth development program during the school year utilizing the system described herein. The system could be configurable to track which youths respond to the E-mails. The youth development program staff might implement other system (and non-system) based procedures for following up with youths that do not respond to the E-mails within a specified time frame. A content of E-mail response might also be utilized as a trigger for youth development program staff to contact the youth, their family, or other persons affiliated with the youth development program. In the example systems and processes, data relating to the development of individual youths may be received and entered into a system database either manually or electronically.

In one embodiment, a computer program is provided, and the program is embodied on a computer readable medium and utilizes a Structured Query Language (SQL) with a client user interface front-end for administration and a web interface for standard user input and reports. In an example embodiment, the system could be web enabled and could be run on a business-entity intranet. In yet another embodiment, the system could be fully accessed by individuals having an authorized access outside the firewall of the business-entity through the Internet. In a further example embodiment, the system could be run in a Windows® NT environment (Windows is a registered trademark of Microsoft Corporation, Redmond, Wash.). The application could be flexible and designed to run in various different environments without compromising any major functionality.

The systems and processes are not limited to the specific embodiments described herein. In addition, components of each system and each process can be practiced independent and separate from other components and processes described herein. Each component and process also can be used in combination with other assembly packages and processes.

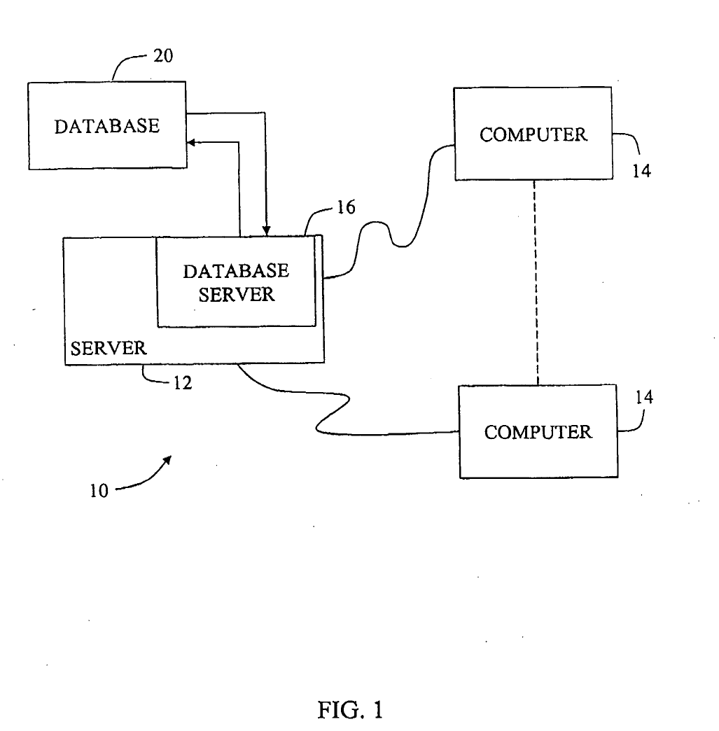

FIG. 1 is a simplified block diagram of a positive youth development system 10 including a server system 12, and a plurality of client sub-systems, also referred to as client systems 14, connected to server system 12. Computerized modeling and grouping tools, as described below in more detail, are stored in server 12 and can be accessed by a requester at any one of computers 14. In one embodiment, client systems 14 are computers including a web browser, such that server system 12 is accessible to client systems 14 using the Internet. Client systems 14 are interconnected to the Internet through many interfaces including a network, such as a local area network (LAN) or a wide area network (WAN), dial-in-connections, cable modems and special high-speed ISDN lines. Client systems 14 could be any device capable of interconnecting to the Internet including a web-based phone, personal digital assistant (PDA), or other web-based connectable equipment. A database server 16 is connected to a database 20 containing information relating to participants in the youth development program, as described below in greater detail. In one embodiment, centralized database 20 is stored on server system 12 and can be accessed by potential users at one of client systems 14 by logging onto server system 12 through one of client systems 14. In an alternative embodiment, database 20 is stored remotely from server system 12 and may be non-centralized.

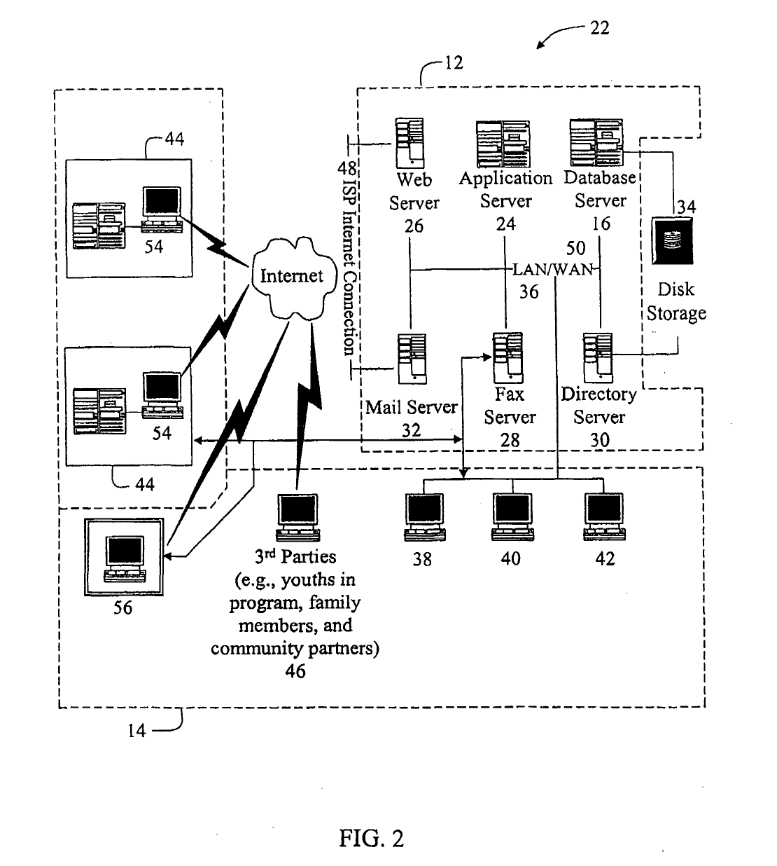

FIG. 2 is an expanded block diagram of an exemplary embodiment of a server architecture for a positive youth development system 22. Components in system 22, identical to components of system 10 (shown in FIG. 1), are identified in FIG. 2 using the same reference numerals as used in FIG. 1. System 22 includes server system 12 and client systems 14. Server system 12 further includes database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator's workstation 38, a user workstation 40, and a supervisor's workstation 42 are coupled to LAN 36. Alternatively, workstations 38, 40, and 42 are coupled to LAN 36 using an Internet link or are connected through an Intranet.

Each workstation 38, 40, and 42 is a personal computer having a web browser. Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36.

Server system 12 is configured to be communicatively coupled to various individuals, including volunteers or employees 44 and to third parties, e.g., including, but not limited to, youths enrolled in the positive youth development program, family members of the youths enrolled in the program, and community partners within the program, 46 using an ISP Internet connection 48. The communication in the exemplary embodiment is illustrated as being performed using the Internet, however, any other wide area network (WAN) type communication can be utilized in other embodiments, i.e., the systems and processes are not limited to being practiced using the Internet. In addition, and rather than WAN 50, local area network 36 could be used in place of WAN 50.

In the exemplary embodiment, any authorized individual having a workstation 54 can access system 22. At least one of the client systems includes a manager workstation 56 located at a remote location. Workstations 54 and 56 are personal computers having a web browser. Also, workstations 54 and 56 are configured to communicate with server system 12. Furthermore, fax server 28 communicates with remotely located client systems, including a client system 56 using a telephone link. Fax server 28 is configured to communicate with other client systems 38, 40, and 42 as well.

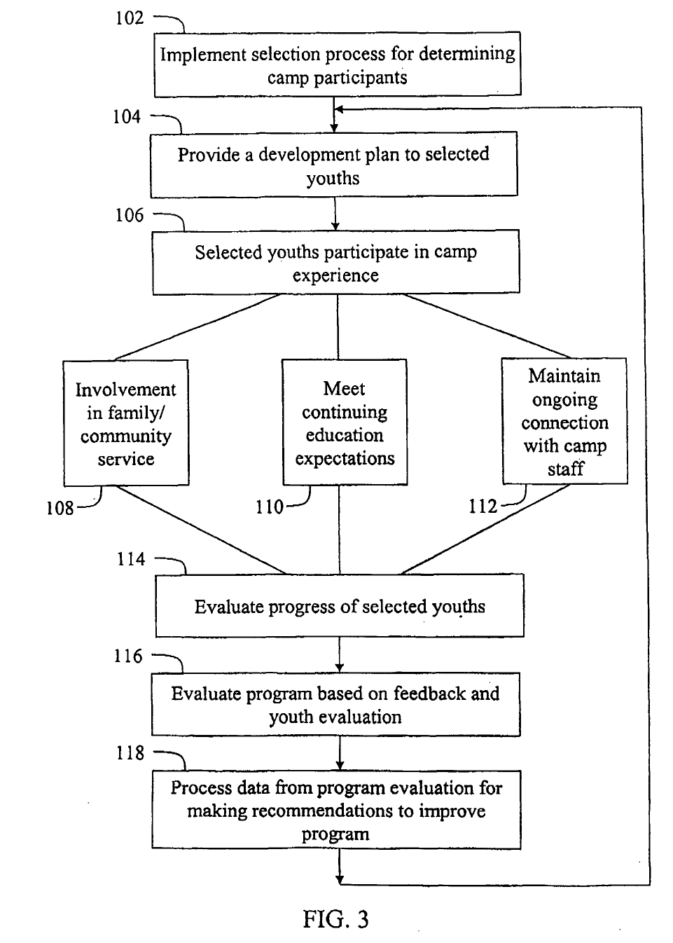

FIG. 3 is a flowchart 100 illustrating an exemplary youth development process, portions of which may be implemented within system 10 (shown in FIG. 1). The technical effect of the processes and systems described herein is achieved when, for example, a youth development coordinator implements 102 a selection process to determine which applicants will be selected to participate in the development program based on records for potential participants stored within the database 20 of system 10. More specifically, data relating to potential youth candidates for the development program is stored within database 20. A selection criteria is applied using server 12 to the data stored in database 20. The server determines which youths from the group of potential candidates satisfy the selection criteria. The youths selected to participate in the program are then selected from the youths satisfying the selection criteria.

After being selected to participate in the development program, each of the selected youths are provided 104 with a development plan that includes a set of goals to be achieved over a specific period of time and a set of tasks to be performed by the selected youth to facilitate achieving the set of goals. The development plan is designed to facilitate providing positive youth development

The selected individuals also participate 106 in a camp experience as described further below. Upon completion of the camp experience, youths are expected to participate in year round development activities, at least a portion of which may be tracked through system 10. For example, individuals enrolled in the youth development program are expected to involve 108 themselves in family and community service, meet 110 continuing education expectations, and maintain 112 an ongoing connection with the camp staff throughout the calendar year until it is time to once again participate 106 in the camp experience. It is understood that these categories may overlap significantly with regard to particular youth activities. However, such activities provide a general understanding as to the types of activities that individuals enrolled in the youth development program, youth development program personnel, and others may report on throughout the year.

In addition, the process includes evaluating 114 the progress of each of the youths included within the development program to determine whether the youths are satisfying the development plan designed specifically for them. The program is also evaluated 116 based on feedback from at least one of the selected youth, the family of the selected youth and the youth development program staff and based on the progress of the selected youth. After the program is evaluated 116, data from the program evaluation is processed 118 and recommendations are made to improve and/or adjust the youth development program.

A member of the youth development program staff or a youth development coordinator creates a record in database 20 of system 10 for each applicant hoping to participate in the youth development program. System 10 may be configured to select participants according to several criteria (e.g., records in database 20) including, but not limited to, an expressed interest and enthusiasm for the program, an ability to maintain at-grade-level school performance or other minimum academic achievement, a demonstrated record of positive behavior in the community and school, come from an environment where significant risk factors exist, have solid parental support, an exhibition of leadership potential, a demonstrated desire to succeed, a demonstrated inability to afford such an opportunity, and an ability to participate fully in the multiple year program.

A summer camp for the selected youths is at the core of the youth development program. In one embodiment, selected individuals are engaged in a five year progressively challenging program, with residential summer camp as the primary program offering. Three to four weeks of residential summer camp occur from years one through three and benchmarks achieved in the camping program may be stored in database 20 of system 10 as a way to track progress of individual youths. For example, the third year may focus on a counselor in training experience and the fourth and fifth years may involve connections to or contact with the residential component of the camp, but may also include broader experiences such as a fourth year extended trek and travel adventure and a fifth year urban community leadership experience. Results of such experiences may be placed into models and stored within system 10, either by the enrolled individuals or the development program personnel for review. Such camps provide camp facilities and programming that are physically and emotionally safe and comfortable while still providing physical and emotional challenges.

System 10 is further configured to monitor and track both a long-term and a year-round commitment and engagement with enrolled individuals in the youth development program. For example, each twelve month program cycle is designed around annual objectives which are stored within database 20 of system 10. These objectives are included within the development plan. Examples of such objectives include, but are not limited to, development of skills in the areas of developing healthy relationships, exploring options and interests, contributing to their communities, respecting human diversity, respecting the environment, graduating from high school, post-high school planning, and developing key leadership skills. The year-round engagement described above may include monthly contact with enrolled individuals via multiple contexts (e.g., newsletters, scheduled program offerings, e-mail, phone) for the five years of the program. In addition and for example, six to seven community learning experiences per year for each class of youth in the development program (e.g., Expanding Horizons, Leadership Retreats, Service Days, Planning Workshops) that connect the camp and community experiences for the youth are included in the development program.

The ongoing connection with camp staff is further enforced since program staff know each individual in the program as well as their families and are able to input data on the progress of the enrolled youth into system 10. In one embodiment, the youth development program includes a system of “coaches” who maintain regular contact with youth and their families during the fourth and fifth years of the program, focusing on post-high school plans. The development staff also maintains contact with community partners regarding availability of community service, extra-curricular activity offerings, and jobs and internships for youth, sharing this information with enrolled youth and coaches.

Youths enrolled in the youth development program are expected to remain or become high performers. Data relating to their high-performance, or lack thereof, is trackable utilizing system 10. One of the requirements of the youth development program is that the youths complete annual community service of at least thirty hours. Other requirements include that they perform at or above grade level academically, maintain at least 97% attendance with zero instances of truancy or unexpected absence, and that they demonstrate appropriate behavior with no office referrals or suspensions at school and no instances of breaking the law. Database 20 is configured to store such school related data, and such data may be input directly by school official, personnel within the youth development program, and in some instances, by the enrolled individuals themselves. These are some of the tasks that may be included within the development plan of each youth included within the program.

In order to facilitate maintaining contact with the staff year-round, the individuals enrolled in the youth development program attend program events in the fall and spring. Additional goals in the youth development program that include data that is suitable for input into system 10 include successful application to three colleges, trade schools or military programs and/or acceptance by at least one. As individuals progress through the youth development program, they begin to actively participate in the planning of their year four and five experiences, and facilitate key parts of these experiences. The youths are also expected to return 100 percent of surveys and assessment tools sent from the program, for example, sent via E-mail from system 10. While at the summer camp, the enrolled youths complete leadership plans which may be stored within system 10. The youths are required to implement these during the school year, and report on them via access to system 10.

In order for such a youth development program to be successful, the youths enrolled therein need to have ownership and governance roles in certain aspects of the youth development program. For example, youth have planning opportunities during the development program, with increasing responsibility during each successive program year. Youth have opportunities to choose different activities and options based on their interests during the program which may be selectable from system 10. Youth have opportunities to practice their leadership skills within the youth development program, including specific program components that are driven and owned by youth committees and backed with staff support (e.g., year book, newsletter). Enrolled individuals are engaged as “partners” during the development program, through a defined governance process including cabin codes, town hall meetings, and cornerstone societies.

As a result of participating in the youth development program, the enrolled individuals develop skills and processes to handle and resolve their interpersonal conflicts, as well as have significant opportunities to affect program content, including input around program design. As a portion of the ongoing connection with youth development staff, youths enrolled in the development program provide yearly feedback for storage within system 10 regarding the support and opportunities within the camp setting, and a committee of youth are engaged in helping staff interpret this stored assessment data.

Intentional family engagement and support content is woven into the youth development program to support parents/guardians as “partners” in supporting their son or daughter's participation and success in achieving program outcomes and their goals. Partner content includes mandatory activities, such as orientation sessions, and optional activities such as active parenting for teens sessions. As part of the partner participation, such partners may also provide certain data and feedback regarding the youth development program to system 10.

Each youth's family participates in at least one sponsored activity at camp or in the community. Families have at least twice yearly contact with staff or coaches, for example, through system 10 and E-mail, as well as personal contact. Parents and staff know each other and demonstrate comfort in discussions and work together. Parents/guardians are also accountable for completion their responsibilities within the program and such progress is monitored utilized system 10. A cadre of community partners is established to nominate and support youth experiences within the community. Each youth has self-selected “advocates” or champions for their participation within their school setting or youth organization and these advocates may provide information to youth development program personnel, for example, by entering such relevant data into system 10. As a result, youth development program personnel have knowledge of each youth's performance, behavior, and attendance at school. Youths know what community resources are available to them in the areas of leadership and service, and are linked to at least one resource in their community as part of this program (e.g., volunteering, internship, after-school activities)

Each youth has a staff member or coach who is the key contact and support during the year. Each youth's progress against their leadership plan, program expectations, and their post-high school planning is tracked intentionally utilizing system 10 and data stored in database 20 by an assigned adult through twice yearly sessions. As a result, youth enrolled in the development program are given feedback and support based on individual progress.

As described above, selection for participation in the youth development program is competitive and based, at least in part, on information applicants provide to the development program staff, for example, data about the applicant that is uploaded into the database 20 of system 10 during the application process. In one embodiment, a minimum of two applicants are nominated for each space in the program from culturally diverse backgrounds that reflect the general population of the area. Nominations are made by community partners (e.g., middle schools, community-based organizations) who have a shared vision and philosophy in providing positive life experiences and outcomes for youth.

In one embodiment, the nomination and selection processes focus on youth with limited means who would be unable to afford or access such an opportunity. In the embodiment, the application process includes four components: a written nomination, a written application, individual interviews, and group interviews. The contents or results of each component can be uploaded into system 10. The selection process results in youths who can appropriately engage within the summer and year-round programs.

Youth selection criteria may include one or more of an expressed interest and enthusiasm for the program by the youths, and the maintaining at-grade-level school performance or other minimum academic achievement (e.g., a minimum of “C” grade point average). Individuals considered for participation in the youth development program should also be able to demonstrate a record positive behavior in the community and school and that they have reliable and consistent adult support for their involvement with the program. Youth are considered that have leadership potential, show indicators of a desire to succeed, and that appear to be able to participate in all five years of the program.

In the example embodiment, system 10 is further configured to, along with youth development program personnel, assess the progress of individuals enrolled in the youth development program, both for the benefit of the individuals, and for those who might find ways to improve or adjust the development program. An assessment plan would include outcome measurements and impact measurements, as well as quality measurements and implementation measurements. Such measurements, performed in conjunction with an E-mail ability and database storage of system 10 include annual camper surveys, annual parent/guardian surveys, annual community partner surveys, annual counselor surveys, and a yearly camper leadership plan. Development plan participants also practice structured journaling, challenge their “comfort zones” by responsible risk taking experiences, and receive monthly phone calls from development program personnel as well as reviews of their academic progress.

Generally, measurements not related to an individual participant are utilized to improve the overall quality of the youth development program and include summer staff surveys, camper satisfaction surveys, parent/guardian satisfaction surveys, a quality control committee report, community partners satisfaction surveys and council of volunteers satisfaction surveys. Staff training, through comprehensive testing, quality committee visits and annual reviews are also utilized, within system 10 to provide a generalized quality assessments for the youth development program.

As stated above, the systems and process described herein also include evaluating the progress of each youth included within the program to determine whether the youths are satisfying their development plan, evaluating the development program based on feedback from at least one of the selected youths, the family of the selected youth and the youth development program staff and based on the progress of the selected youth, and processing data generated from the program evaluation for recommending adjustments to the youth development program.

The methods and systems described herein are based on experience and current research in the areas of asset development, positive youth development, effective assessment of youth outcomes, adolescent development, features of positive developmental settings, active youth involvement, and effective staff training. The systems and processes described herein include an active monitoring of research and practices in the youth development field, as well as testing key strategies in the youth development programs, assessing what is most and least effective, and making quality improvements on a yearly basis.

In the example embodiments described herein, system 10 enables a user to enter data, check progress and generate reports regarding youths applying for enrollment and those currently enrolled in a positive youth development program. As such, the technical effect of system 10 is achieved by receiving, analyzing, and reporting data relating to youths enrolled in the positive youth development program. After receiving data inputs, system 10 determines if the data should become a part of the records for the individual youths that are stored in database 20. Personnel involved in the positive youth development program can then access any stored data to generate reports to determine if the youth is meeting the goals set out in developing the program, many of which are described above.

The above described methods and systems illustrate that the youth development program experience can be regarded as the sum of camp activities, continued connections with youth development program staff, and community and family partner involvement which results in routines and traditions that are respected and followed as well as governance and the promotion of a healthy lifestyle. With respect to camp activities, leadership and service activities are emphasized along with adventure experiences, and social and recreational opportunities. The continued connection with youth development program staff provides ongoing communications opportunities for enrolled youths with positive role models that further include structured events outside of the camp experience which further includes planning processes in which the enrolled youths participate. Finally, community and family involvement vests with the enrolled youths leadership opportunities, an education regarding community service while providing ongoing adult support. All of the above are structured and defined to provide a systematic program that result in promoting positive development in youths and developing community leaders out of youths that under different circumstances may be considered to be at risk developmentally.

While the invention has been described in terms of various specific embodiments, those skilled in the art will recognize that the invention can be practiced with modification within the spirit and scope of the claims.

What is claimed is:

1. A method for promoting positive youth development using a computer system coupled to a database, said method comprising:
selecting youths for inclusion in a youth development program by applying a pre-determined selection criteria to data stored within the database;
providing a development plan to each selected youth, the development plan including a set of goals to be achieved over a specific period of time and a set of tasks to be performed to facilitate achieving the set of goals;
monitoring the selected youth within a residential summer camp portion of the youth development program;
tracking and monitoring of family and community service involvement by the selected youth outside of the summer camp portion of the development program for the selected youth;
tracking and monitoring continuing education expectations of the selected youth; and
verifying an ongoing connection between the selected youths and youth development program staff for a predetermined period of time.

2. A method according to claim 1 further comprising evaluating progress of the selected youths toward satisfying the development plan provided thereto.

3. A method according to claim 2 further comprising recommending adjustments to the youth development program based on the progress of the selected youths.

4. A method according to claim 1 wherein providing a development plan further comprises a development plan including recommended involvement in family and community service, continuing education expectations, and an ongoing connection with the camp staff throughout the calendar year.

5. A method according to claim 1 wherein said step of selecting youths for inclusion in a youth development program further comprises selecting youths for inclusion in a youth development program by applying a predetermined selection criteria, wherein the predetermined selection criteria includes at least one of an expressed interest and enthusiasm for the program, an ability to maintain at-grade-level school performance or other minimum academic achievement, a demonstrated record of positive behavior in the community and school, an environment with significant risk factors, solid parental support, an exhibition of leadership potential, a demonstrated desire to succeed, a demonstrated inability to afford such an opportunity, and an ability to participate fully in the multiple year program.

6. A method according to claim 1 wherein the youth development program further includes a five year progressively challenging plan, wherein each year of the first three years of the plan including three to four weeks of residential summer camp.

7. A method according to claim 6 wherein said step of monitoring the selected youth within a residential summer camp portion further comprises storing in the database benchmarks achieved by the selected youths.

8. A method according to claim 6 wherein each year includes a twelve month program cycle designed around annual objectives stored within database.

9. A method according to claim 8 wherein the annual objectives including at least one of graduating from high school, post-high school planning, developing key leadership skills, exploring options and interests, contributing to their communities, respecting human diversity, and respecting the environment.

10. A method according to claim 1 wherein said step of selecting youths further comprises selecting youths for inclusion in a youth development program, wherein the development program requires selected youths to accomplish at least one of annual community service of at least thirty hours, performance at or above grade level academically, and at least 97% attendance with zero instances of truancy or unexpected absence.

11. A method according to claim 1 further comprising receiving an application regarding each of the selected youths, wherein the application including four components including a written nomination, a written application, individual interviews, and group interviews.

12. A method according to claim 11 wherein said step of receiving an application further comprises uploading to the computer system contents or results of each component of the application.

13. A method according to claim 1 further comprising evaluating the development program based on feedback from at least one of the selected youths, the family of the selected youths, and the youth development program staff.

14. A method according to claim 13 wherein said step of evaluating the development program further comprises processing data generated from the feedback of the youth development program.

15. A method according to claim 1 further comprising enabling a user via the computer system to monitor progress of selected youths, generate a report regarding youths applying to the program, and generate a report regarding the progress of selected youths in the program.

16. A network-based system for promoting positive youth development, said system comprising:
a server system;
a database for storing information;
at least one client system;
said server system connected to said database and to the at least one client system, said server system configured to:
apply a selection criteria to data stored within the database, said data relating to a group of youth candidates;
select youths from the group of youth candidates to participate in a youth development program, said selected youths satisfying the selection criteria applied to data stored within the database;
generate a development plan for the selected youth, the development plan including a set of goals to be achieved over a specific period of time and a set of tasks to be performed to facilitate achieving the set of goals;
receive input data relating to the selected youth, said input data including data relating to the youth's participation in school and within a residential summer camp;
track progress of the selected youth in satisfying the development plan provided thereto;
compare the progress of each of the selected youth to the development plan assigned to the corresponding youth; and
receive feedback data from at least one of the selected youths, the family of the selected youths, and the youth development program staff.

17. A system according to claim 16 wherein said server further configured to evaluate a progress of the selected youth toward satisfying the development plan provided thereto.

18. A system according to claim 17 wherein said server further configured to recommend adjustments to the youth development program based on the progress of the selected youth.

19. A system according to claim 16 wherein the development plan includes recommended involvement in family and community service, continuing education expectations, and an ongoing connection with the camp staff throughout the calendar year.

20. A system according to claim 16 wherein said server further configured to select youths for inclusion in a youth development program by applying a predetermined selection criteria, wherein the predetermined selection criteria includes at least one of an expressed interest and enthusiasm for the program, an ability to maintain at-grade-level school performance or other minimum academic achievement, a demonstrated record of positive behavior in the community and school, an environment with significant risk factors, solid parental support, an exhibition of leadership potential, a demonstrated desire to succeed, a demonstrated inability to afford such an opportunity, and an ability to participate fully in the multiple year program.
